(19) United States
(12) Patent Application Publication
(10) Pub. No.: US 2016/0056975 A1
(43) Pub. Date: Feb. 25, 2016

(54) System and Method for Virtualizing an IT Infrastructure with Remotely Accessible Virtual Desktops

(71) Applicant: Conexlink, LLC, Carrollton, TX (US)

(72) Inventor: Pablo Marin, Carrollton, TX (US)

(21) Appl. No.: 14/467,196

(22) Filed: Aug. 25, 2014

(51) Int. Cl. H04L 12/46; H04L 29/06

(52) U.S. Cl. CPC H04L 12/4641; H04L 67/40; H04L 69/161

(57) ABSTRACT

A system and method for virtualizing an IT infrastructure providing remotely accessible virtual desktops. The system includes a portal for interfacing with a user to obtain and display IT infrastructure configuration and operating data. The system also includes platform creation module for creating, on a computer network accessible IT infrastructure platform device, a virtual computer network accessible over the TCP/IP computer network and comprising at least one remotely accessible virtual desktop. The platform creation module performs such operation automatically through use of specialized software scripts.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to computer networking technology.

2. Description of Related Art Including Information Disclosed Under 37 CFR 1.97 and 1.98

When creating a computer network for data exchange within an office environment, companies typically employ an information technology (IT) specialist whom assesses the company's IT infrastructure needs and assembles and configures the hardware necessary to realize the network. The typical computer network hardware requirements can be rather extensive, including firewalls, gateway servers, domain name servers (DNS), routers, bridge routers, data servers, and a multitude of connected personal computers or workstations for use by employees. This hardware, once installed and configured, then requires constant monitoring and ongoing attention by the IT professional, who maintains the software by applying patches and upgrades as necessary, repairs or replaces faulty hardware, and reconfigures or upgrades the hardware as the company's needs change. This represents a tremendous expense for the company in labor, hardware, and licensing costs, and is often one of the largest budgets a company must face.

Once such a network is established, it can then be rather costly and difficult to modify. For example, the addition of a new employee requires configuration and addition to the network of another personal computer. If the network or sub-network (to which the new computer must be added) happens to be out of IP addresses, additional router hardware may be required to establish the new network and to complete the computer connection, which further increases the configuration and maintenance burdens faced by the IT personnel.

In an effort to minimize physical hardware configuration and maintenance requirements, many computing tasks have been moved into the “cloud” computing space. The “cloud” is essentially a gigantic collection of servers with excess hard drive storage space that are configured to accept user computer connections over the Internet and that allow the user to access data and programs (applications) that run on the “cloud” servers. The cloud programs (applications) typically run on virtual computing machines (virtual machines) that support instances of an operating system that run within the cloud environment and perform the computing functions as with a typical desktop computer. However, although using the cloud environment to host various computing services might reduce the actual overall network hardware requirements, the complexities are such that an IT professional is still required to configure and manage the virtual components of the network in addition to the physical components of the network and the added complexities of virtual machines. Moreover, the functionality provided by the cloud computing service is often limiting, which means that certain portions of a traditional computer network with user desktop computers might not be realizable within the cloud computing virtual space. What is needed is a system and method through which a relatively non-technical person can realize a complete virtual computing network and that provides user desktop applications that a user may remotely access, thereby essentially eliminating the physical hardware requirements of a traditional business computer network and essentially eliminating the need for dedicated IT professionals. The present invention satisfies this need and others, as will become readily apparent upon a thorough consideration of the disclosure provided herein.

### BRIEF SUMMARY OF THE INVENTION

The present invention provides a system for virtualizing an information technology (IT) infrastructure, the system comprising: a computer network accessible IT infrastructure platform device, the IT infrastructure platform device comprising computing resources adapted to support the operation and TCP/IP connectivity of a plurality of virtual machines thereon; and a computer network accessible IT infrastructure portal device in network communication with the IT infrastructure platform device, the IT infrastructure portal comprising a platform management interface for requesting and receiving platform configuration data from a configuration user and for presenting IT infrastructure platform data to the configuration user, the portal further comprising a platform creation module adapted to create on the IT infrastructure platform device a virtual computer network accessible over the TCP/IP computer network and comprising at least one remotely accessible virtual desktop.

Variations on this system include embodiments wherein the platform creation module configures and manages the IT infrastructure platform device based upon the received platform configuration data, wherein the received platform configuration data includes a count of the desired number of virtual desktops and a desired storage capacity size value representing the desired shared hard drive storage space to allocate within the IT infrastructure platform; a desktop user management interface for managing remote desktop user accounts provided by the IT infrastructure portal; a virtual machine management interface for managing the virtual machines provided by the IT infrastructure portal; one or more virtual machines operable as a remote desktop gateway server, one or more virtual machines operable as a remote desktop connection broker server, one or more virtual machines operable as a remote desktop web access server, one or more virtual machines operable as a remote desktop session host server, and one or more virtual machines operable as a domain name server, wherein each virtual machine is in network connectivity to provide a desktop user with a remotely accessible virtual desktop; one or more virtual machines operable as an active directory domain controller and one or more virtual machines operable as an active directory federation server.

Other embodiments of the server include platform configuration data comprising: a desired storage capacity size value representing shared hard drive storage space within the created IT infrastructure, and a hard drive storage space created by the platform creation module, the storage space capacity determined by a received storage capacity size value, wherein the hard drive storage space is shared among the remote desktops; a count of the desired number of virtual desktops for the created IT infrastructure, and wherein the number of virtual machines operable as a remote desktop session host server is determined by a received count of the desired number of virtual desktops; a listing of one or more software applications accessible by a remote desktop user, and software applications consistent with a received listing of software applications and provided by the desktop session host servers.

The present invention further provides a method for virtualizing an information technology (IT) infrastructure, the method steps comprising: providing a computer network accessible IT infrastructure platform device, the IT infrastructure platform device comprising computing resources adapted to support the operation and TCP/IP connectivity of a plurality of virtual machines thereon; providing a computer network accessible IT infrastructure portal in network communication with the IT infrastructure platform device, the IT infrastructure portal comprising a platform management interface for requesting and receiving platform configuration data from a configuration user and for presenting IT infrastructure platform data to the configuration user, the portal further comprising a platform creation module adapted to create on the IT infrastructure platform device a virtual computer network accessible over the TCP/IP computer network and comprising at least one remotely accessible virtual desktop.

Variations on the method include method steps further comprising, with the platform creation module, creating, on the IT infrastructure platform device, one or more virtual machines operating as a remote desktop session host server to provide remote desktop access to one or more remote desktop users; creating, on the IT infrastructure platform device, one or more virtual machines operating as a remote desktop session host server, one or more virtual machines operating as a remote desktop connection broker server, one or more virtual machines operating as a remote desktop web access server, and one or more virtual machines operating as a remote desktop gateway server to provide remote desktop access to one or more remote desktop users; with the platform creation module, creating, on the IT infrastructure platform device, one ore more virtual machines operating as an active directory domain controller server, and creating, on the IT infrastructure platform device, one ore more virtual machines operating as an active directory federation server. When the platform configuration data comprises a desired storage capacity size value representing shared hard drive storage space within the created IT infrastructure, the method steps further comprise creating, on the IT infrastructure platform device, a hard drive storage space consistent with a received storage capacity size value wherein the hard drive storage space is shared among the remote desktops. When the platform configuration data comprises a count of the desired number of virtual desktops for the created IT infrastructure, the method steps further comprise creating, on the IT infrastructure platform device, a number of remote desktop session host servers consistent with a received count of the desired number of virtual desktops. When the platform configuration data comprises a listing of software applications accessible by a remote desktop user, the method steps further comprise installing, on the created desktop session host servers, software applications consistent with a received listing of software applications, the installed software applications accessible from a remote desktop session.

The present invention further provides a method for virtualizing an information technology (IT) infrastructure, the method steps comprising: providing a computer network accessible IT infrastructure portal in network communication with a computer network accessible IT infrastructure platform device, the IT infrastructure portal comprising a user interface for requesting and receiving platform configuration data from a configuration user and for presenting IT infrastructure platform operational data to the configuration user, the IT infrastructure portal further comprising a platform creation module; receiving, with the IT infrastructure portal, platform configuration data from a configuration user, the platform configuration data including a count of a desired number of virtual desktops; and creating, on a computer network accessible IT infrastructure platform device and in response to the received platform configuration data, one or more virtual machines operating as a remote desktop session host server, one or more virtual machines operating as a remote desktop connection broker server, one or more virtual machines operating as a remote desktop web access server and one or more virtual machines operating as a remote desktop gateway server to provide remote desktop access to a desktop user.

Variations on the method include method steps further comprising, creating, on the IT infrastructure platform device, one ore more virtual machines operating as an active directory domain controller server; and creating, on the IT infrastructure platform device, one ore more virtual machines operating as an active directory federation server. When the platform configuration data comprises a desired storage capacity size value representing shared hard drive storage space within the created IT infrastructure, the method steps further comprise creating, on the IT infrastructure platform device, a hard drive storage space consistent with a received storage capacity size value wherein the hard drive storage space is shared among the remote desktops. When the platform configuration data comprises a count of the desired number of virtual desktops for the created IT infrastructure, the method steps further comprise creating, on the IT infrastructure platform device, a number of remote desktop session host servers consistent with a received count of the desired number of virtual desktops. When the platform configuration data comprises a listing of software applications accessible by a remote desktop user, the method steps further comprise installing, on the created desktop session host servers, software applications consistent with a received listing of software applications, the installed software applications accessible from a remote desktop session.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a network diagram depicting the interconnectivity and dependency of the various components of a first and second embodiment of the present invention;

FIG. 2 is a block diagram of the elements of an embodiment of the IT infrastructure platform device of the present invention;

FIG. 3 is an abstracted layer diagram of an embodiment of the IT infrastructure portal device of the present invention;

FIG. 4A-F is a flow diagram of an embodiment of the program steps taken by the IT infrastructure portal platform creation module when creating and configuring the virtual computer network and remotely accessible virtual desktops;

FIG. 5 is a flow diagram of an embodiment of a subset of the program steps taken by the platform creation module with regard to creation and configuration of virtual machines;

FIG. 6 is a flow diagram of an embodiment of a subset of the program steps taken by the platform creation module with regard to adding a user to the system;

FIG. 7 is a flow diagram of an embodiment of a subset of the program steps taken by the platform creation module with regard to modifying established user accounts;

FIG. 8 is a flow diagram of an embodiment of a subset of the program steps taken by the platform creation module with regard to configuration of the remotely accessible desktops to support a productivity software application;

FIG. 9A-B is a flow diagram of an embodiment of a subset of the program steps taken by the platform creation module with regard to synchronizing supported productivity software application data with the respective user desktops;

FIG. 10A-B is a flow diagram of an embodiment of a subset of the program steps taken by the platform creation module with regard to management of shared disk storage space for the created user desktops;

FIG. 11 is a depiction of an embodiment of a first screen of the user interface as provided by the IT infrastructure portal, in particular, the interface that a configuration user sees when logging into the system;

FIG. 12 is a depiction of an embodiment of a second screen of the user interface as provided by the IT infrastructure portal, in particular, the interface for managing the IT infrastructure platform device virtual computer network;

FIG. 13 is a depiction of an embodiment of a third screen of the user interface as provided by the IT infrastructure portal, in particular, the interface for editing a created IT infrastructure platform device virtual computer network;

FIG. 14 is a depiction of an embodiment of a fourth screen of the user interface as provided by the IT infrastructure portal, in particular, the interface for editing a created user account;

FIG. 15 is a block diagram of the elements of another embodiment of the IT infrastructure platform device of the present invention; and

FIG. 16 is a block diagram of the elements of yet another embodiment of the IT infrastructure platform device of the present invention.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

As may be used herein “computer readable medium” or “computer readable media” means any tangible portable or fixed RAM or ROM device, for example, portable flash memory, a CDROM, a DVDROM, embedded RAM or ROM integrated circuit devices, or the like, and includes non-volatile and/or volatile storage, for example, dynamic ram or the like. Software code required to implement the various program steps described herein will, necessarily, require storage on such a “computer readable medium” for persistent storage.

Various aspects of the present invention may be described with reference to a general-purpose computer system, also known as an “automated computing device” or simply “computing device.” As used herein, the term “automated computing device,” or “computing device,” means a device capable of executing program instructions as streamed or as requested from attached volatile or non-volatile memory. For example, such a device utilizes a microprocessor, microcontroller, or digital signal processor in signal communication with a memory component (RAM, ROM, etc.), one or more network interface components (NIC, Wi-Fi, Bluetooth, Zigbee, LTE, and the like), one or more user input components (keyboard, mouse, touchscreen, etc.), one or more user output or display components, and/or additional peripheral components including a database for bulk data storage. The computing device and database may also utilize a standard operating system upon which the program instructions may be executed (OS X, iOS, Linux, UNIX, Android, Windows, etc.) or may utilize a proprietary operating system for providing basic input/output. Examples include, but are not limited to, a mainframe computer, workstation computer, database server, personal computer, laptop computer, notebook computer, tablet computer, smartphone, PDA, or the like, or some combination thereof. A computing device running a database management application, for example, MySQL, Oracle Database, SQL Server, and the like is a “computer server” or a “database server” as is commonly known and understood.

As used herein, the term “computer network” or “communication network” means any telecommunications network that allows computing devices to exchange data over wired and/or wireless connections. Such a network also allows for distributed processing, for example, through website and database hosting over multiple computer network connected computing devices. The present invention may utilize one or more such networked computing devices, with each device physically residing in different remote locations, including in the “cloud” (i.e., cloud computing over the Internet). As used herein, the term “online” means, with respect to a computing device, that the computing device is in computer network communication with one or more additional computing devices. The term “online” means, with respect to a user of a computing device, that the user is utilizing the computing device to access one or more additional computing devices over a computer network.

Various aspects of the present invention may be performed by one or more computer systems, and may be centralized or distributed among more than one system. The invention is not limited to any particular hardware implementation. Moreover, it should be understood that the invention is not limited to a particular computer system platform, processor, operating system, or network. Also, it should be apparent to those of ordinary skill in the art that the present invention is not limited to a specific programming language or computer system and that other appropriate programming languages and other appropriate computer systems could also be used, alone or in combination with others. Selection of an appropriate programming language with regard to the application requirements, including hardware requirements, is commonly understood and practiced.

As previously stated, the “cloud” is essentially a gigantic collection of physical computer servers with tremendous amounts of hard drive storage space that are configured to accept user computer connections over the Internet or other computer network, and that allows the user to access data and programs (applications) that run on the “cloud” servers. The gigantic collection of servers typically exists in a datacenter facility, which feature redundant systems (computing, power, cooling, security, etc.) to ensure uninterrupted operation and access. Some datacenter providers feature redundant datacenters that are geographically remote to ensure that a catastrophe in one will not affect the other. The end user typically remains unaware of the physical location or makeup of the cloud resources being accessed, hence, the appropriateness of the term “cloud computing.” Such computing resources are now viewed as a commodity, with end users able to purchase resources as they would utilities, paying only for the resources used without concern regarding the underlying hardware. Current commercial cloud computing providers include Microsoft Cloud, Amazon Web Services (AWS), Google Cloud Platform, and VMware vCloud.

The term “virtual computing device” or “virtual machine” means a software computer that, like a physical computer (i.e., computing device), operates to support the running of an operating system and related software applications. A virtual machine is specialized software application that is comprised of a set of specification and configuration files, and is hosted by the physical resources of a physical computer (a host computer). The virtual machine has virtual devices that provide the same functionality as physical hardware, with the added benefit of portability, manageability, operational stability, and security. The virtual machine begins as a specialized software application that mimics the basic operational environment of a physical computer, with tools and resources that allow a user to manage the specialized operational environment as one normally manages a physical computer's hardware. Installation and operation on a host computer of a virtual machine specialized software application represents a single instance of a virtual machine. A guest operating system (for example, Windows®, Linux®, etc.) may then be installed to run within the specialized operating environment on the virtual machine. Software applications may then be installed to run on the guest operating system (for example, Windows® Office® productivity tools and the like) as if they were being installed and run on a physical computer. If the host computer physical hardware is sufficiently adequate (i.e., processor speed, memory, etc.), then multiple virtual machine instances may be installed, thereby supporting multiple guest operating systems and application sets on a single physical host computer. The installation, configuration, and operation of virtual machines are commonly understood.

As used herein, the term “web browser” means any software application for retrieving, presenting, or traversing information over a computer network (e.g., Safari, Firefox, Netscape, Internet Explorer, Chrome, and the like). A web browser accepts as an input a network address, and provides a page display of the information available at that network address. Appropriate web browser programming scripts, for example, JavaScript, VBScript, ActiveX Scripting, Tcl, and the like may be utilized to realize the appropriate browser functionality described herein.

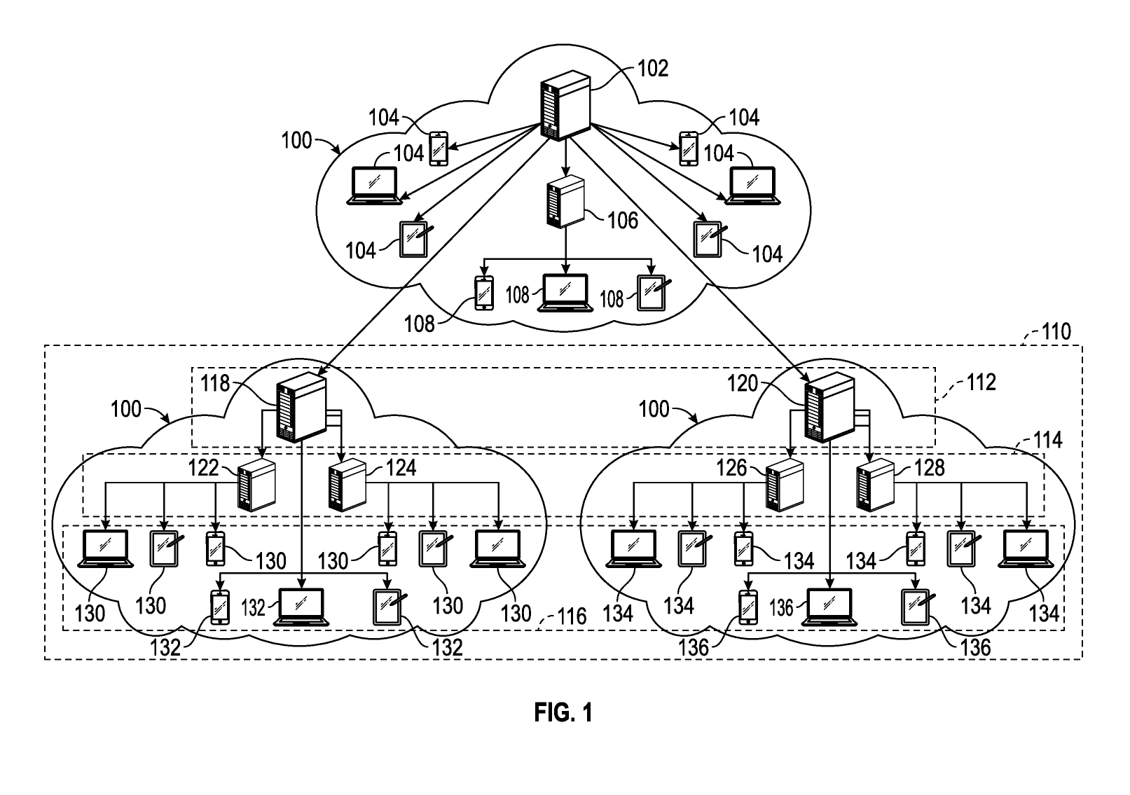

FIG. 1 is a network diagram depicting the interconnectivity and dependency of the various components of a first and second embodiment of the present invention. In basic form of a first embodiment, components of the system include the IT infrastructure portal (102) in network communication with the IT infrastructure platform device (100). Also in network communication with the IT Infrastructure portal (102) are any number of configuration user computing devices (104) that access the portal (102) through the user device (104) web browser. The present embodiment utilizes the computing device web browser as an interface, while other embodiments may utilize a dedicated graphical user interface capable of retrieving, presenting, and traversing data over the network as described herein. It is also possible for a reseller (106) of the services provided by the invention to operate as a configuration user and to provide the configured services to any number of end users (108). A second embodiment addresses business opportunities that exist with the addition of service distributors (112) operating within independent IT infrastructure platform devices (110), in conjunction with resellers (114) and end users (116). In the second embodiment individual distributors (118 and 120) operate as the IT infrastructure portal, accepting connections from resellers of the service (122, 124, 126, and 128), which act as the configuration user. End users (132 and 136) may purchase and access the resulting service directly through the distributors (118 and 120), while other end users (130 and 134) may purchase and access the service through the resellers (122, 124, 126, and 128).

In the present embodiment the IT infrastructure platform device (100) is realized using the commercially available Microsoft Azure service running in the Microsoft Cloud. However, other embodiments may utilize similar cloud services capable of providing sufficient resources adapted to support the operation and TCP/IP connectivity of a plurality of virtual machines configurable as described herein, and may even utilize a private cloud controlled by the configuration user.

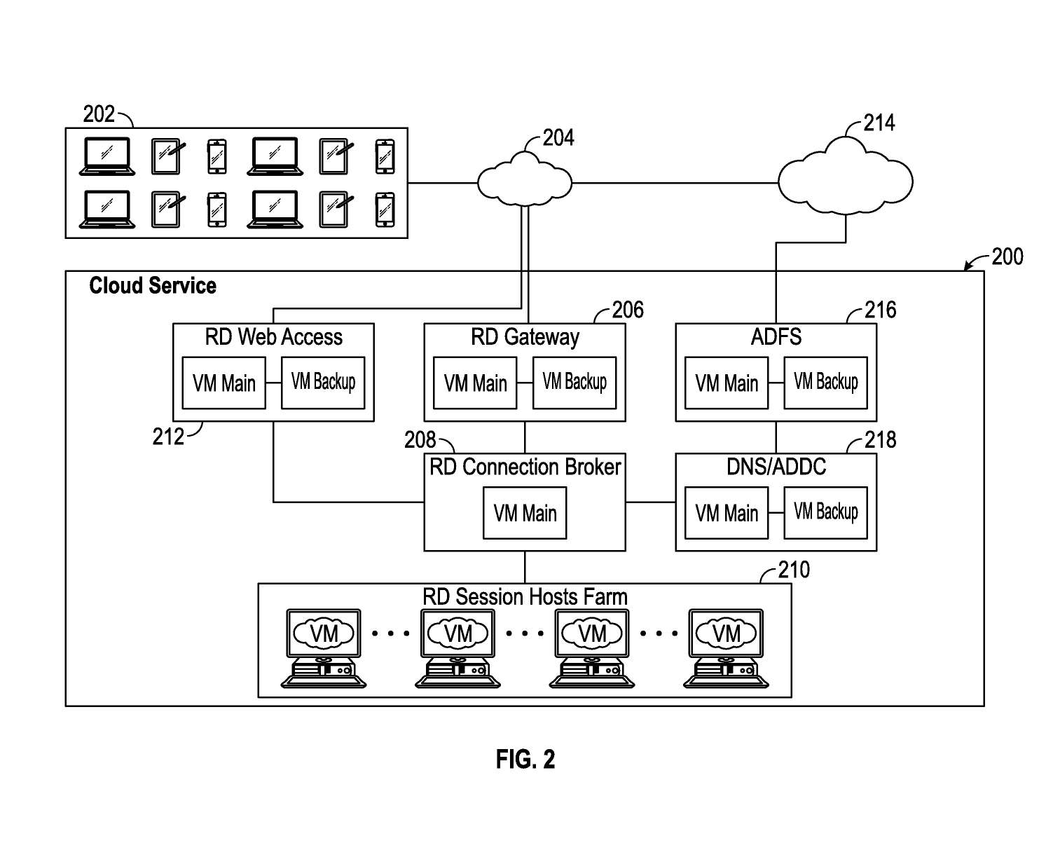

FIG. 2 is a block diagram of the elements of an embodiment of the IT infrastructure platform device of the present invention. As depicted, a full virtual computer network has been realized within the IT infrastructure platform using the IT infrastructure portal platform creation module as described herein. The virtual network (200) comprises the basic hardware and functionality as with a traditional computer network, albeit on virtual machines. By realizing the entire IT virtual network infrastructure within the cloud, a client user (202) may access a remote desktop (210) located remotely from the user (202). The remote desktop (210) provides identical computer desktop functionality as though it were on a local physical computer device. Consequently, the user experience is not changed and the user (202) operates as though the desktop is on the user's local computer device and is connected to other user computer and resources as in the traditional office environment, including access to shared data storage and peripherals.

Client users (202) access the virtual network over an Internet or other network connection (204) by utilizing the Remote Desktop Connection (RDC) application available on the local computer (in the case of a Microsoft Windows computer), or may utilize any other commonly known remote desktop application supporting the Remote Desktop Protocol (RDP). The connection would occur through the remote desktop gateway (206), and would access the user's virtual desktop through a remote desktop connection broker (208) in communication with the remote desktop session hosts farm (210). Again, each of the RD gateway (206) and RD connection broker (208) are operating on virtual machines, and may even operate with redundancy as a main virtual machine and a backup virtual machine as depicted with the RD gateway (206). A virtual DNS server (218) provides domain name resolution for the virtual network to allow machines to resolve addresses as in a physical computer network. A remote desktop web access virtual machine (212) may also be provided. The RD web access device enables users to access the remote desktop connection (210) through the Start menu on a computer that is running a PC or UNIX-based operating system or through a Web browser.

The virtual computer network (200) may also provide access to productivity software applications (214) on the user desktops (210). In the present embodiment, the users have access to Microsoft Office 365 service (214), which requires operation of an active directory federation server (216). Again, this AD federation server operates as a virtual machine, and may also include a backup virtual machine for redundancy (216). The DNS server (218) may also operate as an active directory domain controller for full Microsoft Windows network functionality. While the present embodiment deals primarily with the Microsoft Windows network environment, other operating systems and configurations are also envisioned. For example, Linux and UNIX variants are also possible and are contemplated herein, as each shares similar network device requirements with the exception of the Active directory devices (virtual or otherwise).

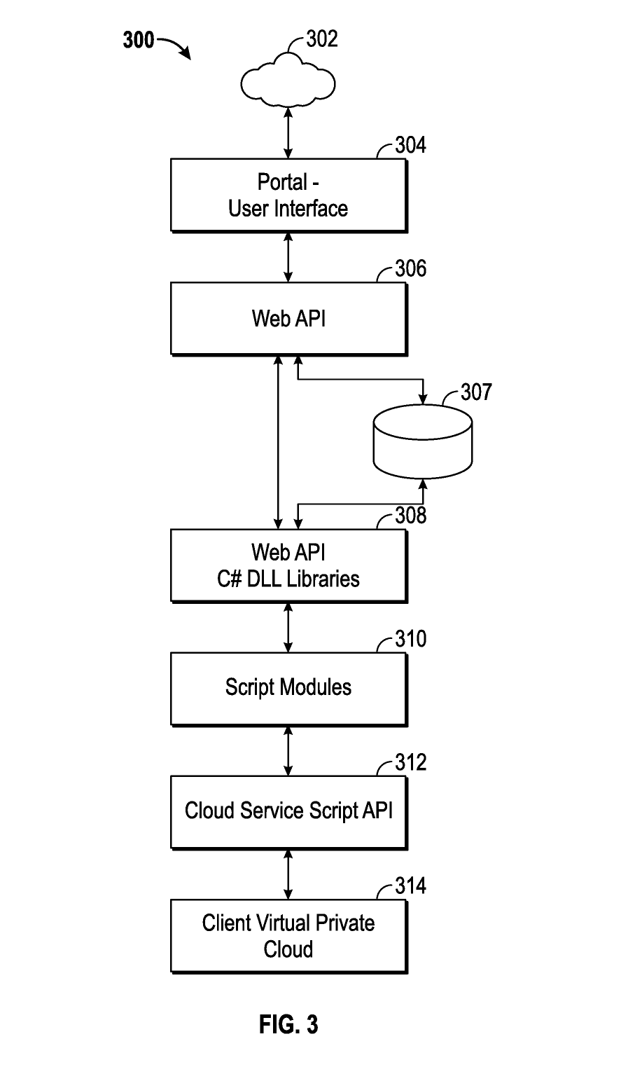

FIG. 3 is an abstracted layer diagram (300) of an embodiment of the IT infrastructure portal device of the present invention, and its connectivity within the overall system. The portal device includes a platform management interface and a platform creation module. As depicted, a configuration user computing device connects to the portal (304) via a computer network (302), and is presented with an HTML document that displays in a web browser on the user's computing device and provides an organized means through which to effect the traversal of data between the system and the configuration user. Standard web application programming languages and techniques are utilized to create the user interface and to facilitate the data exchange. For example, in this embodiment HTML 5 standard compliant HTML code is utilized, in conjunction with standard AngularJS scripts to provide dynamic operation to the underlying static HTML code. Additional functionality is provided by use of the ASP.NET Web API (306) and C# DLLs (308) to facilitate the movement of data to and from a relational database device (307), which persists user and system configuration data. Again, standard programming techniques are employed to achieve the functionality stated herein. It is well understood that other programming languages appropriate for the desired hardware and functionality may also be used in the development and operation of an embodiment.

Once registered with the IT infrastructure portal device, the configuration user is presented by the portal (304) with a user interface requesting configuration instruction from the user. The user inputs the appropriate data into the page fields, and the data is posted to the portal. The data is stored within the database (307) if necessary, and directed to the platform creation module where the appropriate IT infrastructure platform device virtual computer network creation scripts (310) are activated. In this embodiment the IT infrastructure platform utilizes the Microsoft Azure cloud hosting service. Accordingly, the platform creation module utilizes standard Microsoft Windows PowerShell scripts based on the Windows Azure PowerShell module to effect creation and management of the virtual machines and virtual computer network created thereon. Other embodiments that utilize different cloud hosting services will utilize standard scripting languages that are appropriate for the particular cloud hosting service. The PowerShell scripts (310) of the platform creation module operate at every level of the Windows Azure infrastructure managing high level services such as subscriptions, storage accounts (312), and Platform-as-a-Service features like, virtual networks, cloud services, and virtual machines (314).

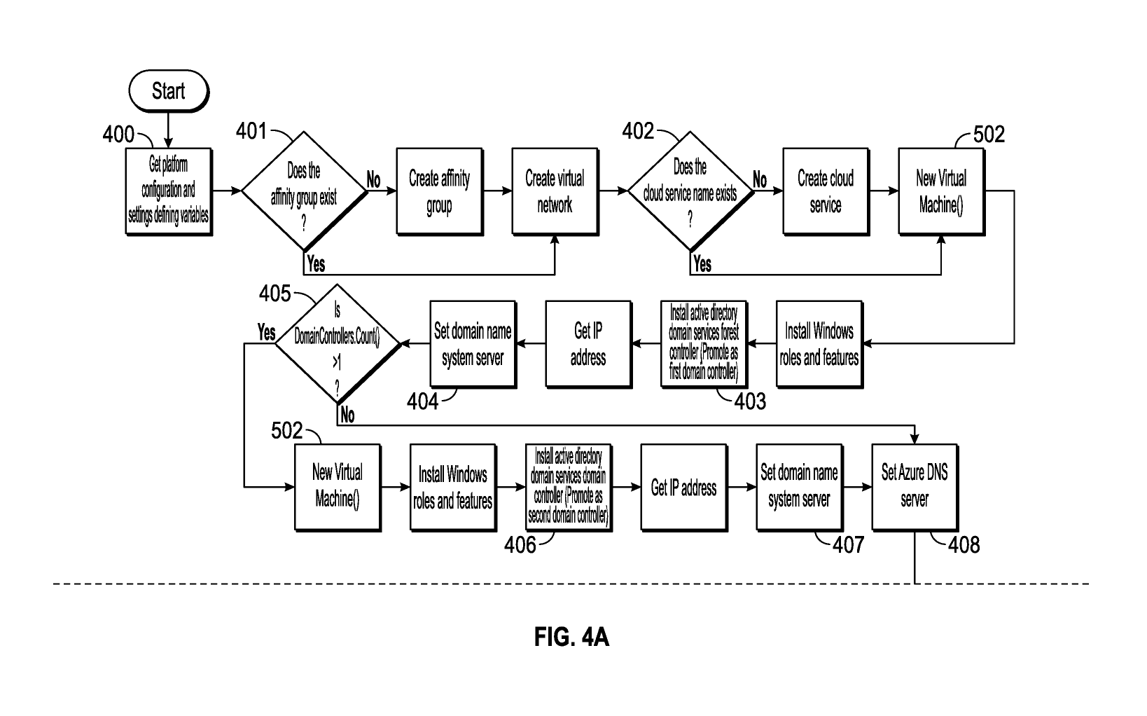

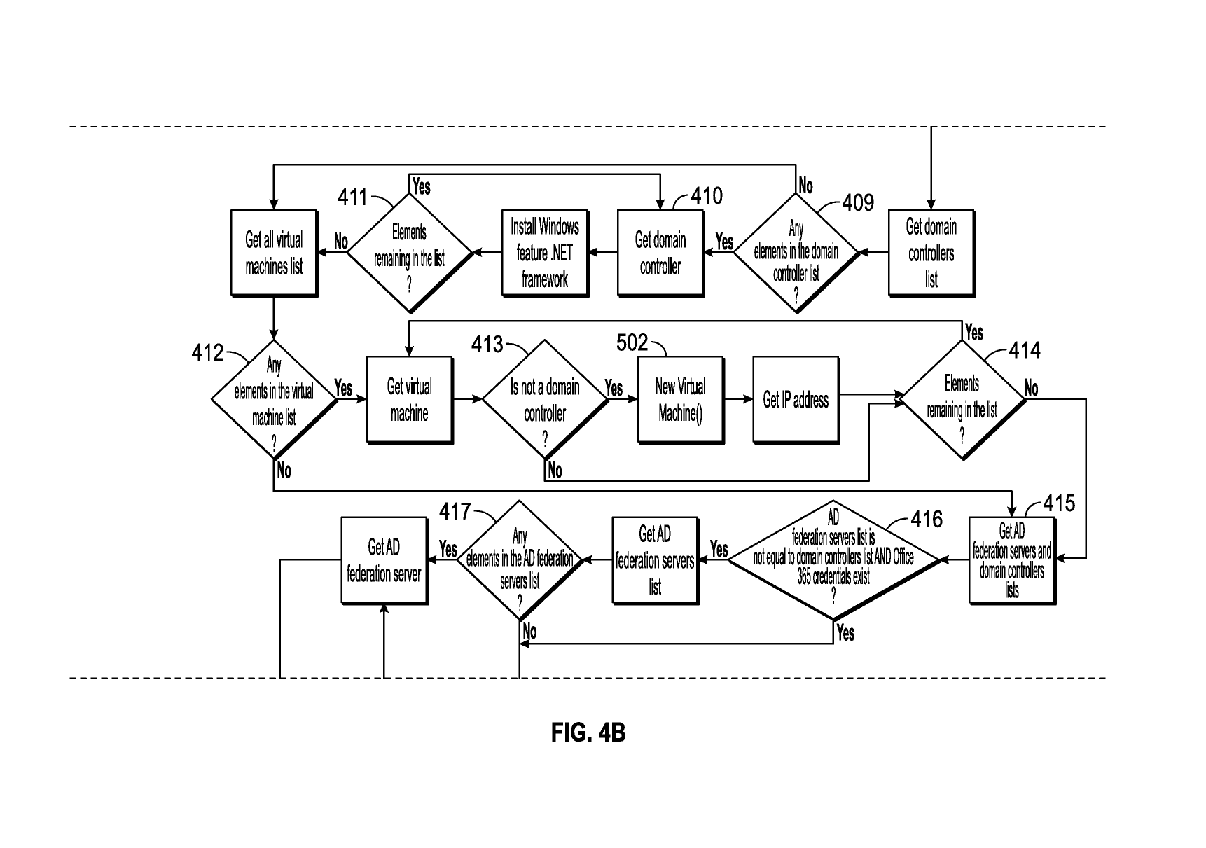

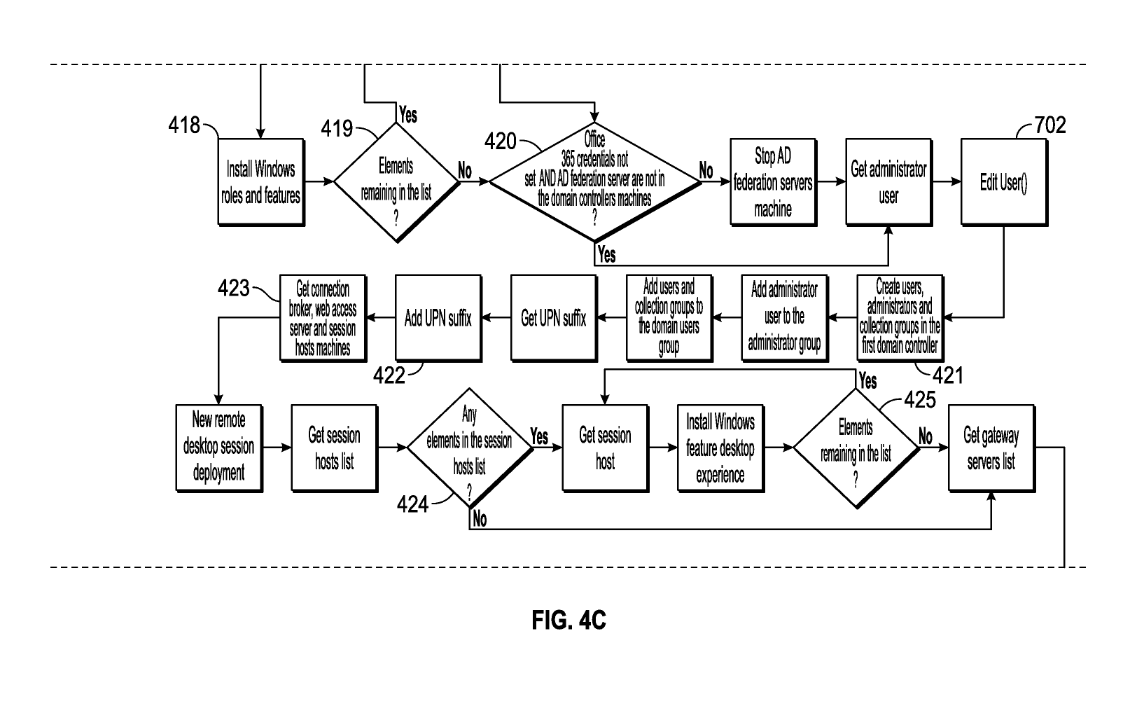

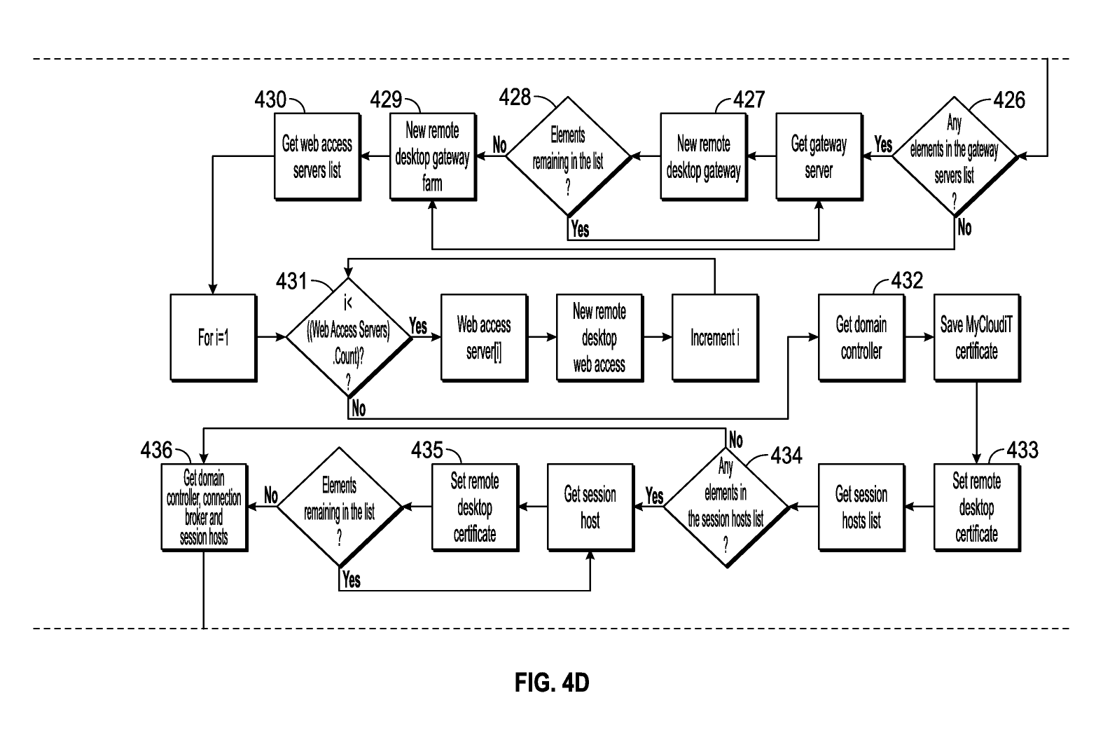

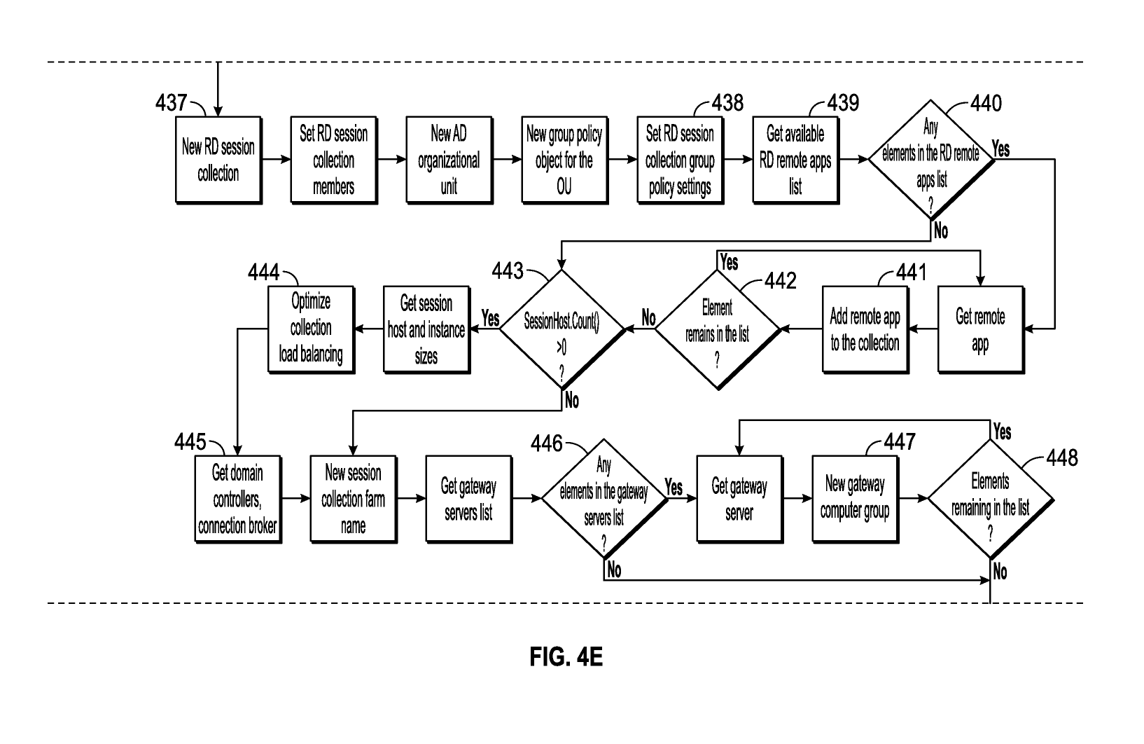

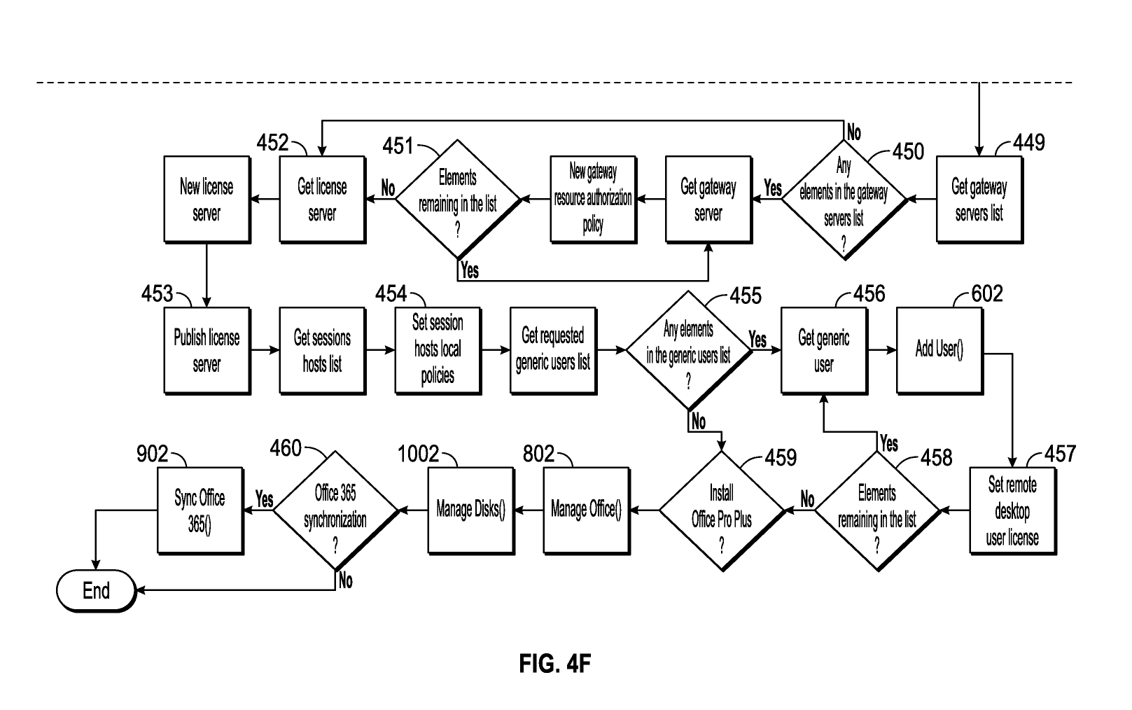

FIG. 4 is a flow diagram of an embodiment of the program steps taken by the IT infrastructure portal platform creation module when creating and configuring the virtual computer network and remotely accessible virtual desktops. This figure (which is broken into 4A through 4F because of its size) represents high-level steps performed by the platform creation module when creating and configuring the IT infrastructure platform virtual computer network on the Microsoft Azure cloud service. In the present embodiment the functionality is implemented using common Windows PowerShell script programming techniques, but in other embodiments may be implemented using other scripting languages or high-level programming languages appropriate for the chosen cloud service and hardware. Moreover, the cloud service provider determines the requirements for the exact scripting order and steps, which may vary from the described embodiment but yet are contemplated herein.

To begin, referring to FIG. 4A, the module obtains from the configuration user the desired platform configuration and settings defining variables data (400) from the portal platform management interface. Within the platform configuration data there are lists of elements pertaining to desired virtual machines stating the characteristics and roles that each virtual machine plays within the virtual network. For example, certain virtual machines will serve as active directory federation servers, domain controllers, domain name service (DNS) servers, remote desktop gateways, remote desktop connection and/or licensing brokers, remote desktop web access servers, or remote desktop session host servers. A determination is first made as to whether an affinity group has been created previously for use with the virtual network (401). If no affinity group exists, then the affinity group is created prior to beginning creation of the virtual network. Assigning an affinity group is a way that one can group cloud services by physical proximity within a datacenter to achieve optimal performance of the computing resources. What this means is that the virtual machines within a defined affinity group will reside within the same physical server or on server hardware that is in as close of proximity as possible within the datacenter to reduce latency, increase performance, and possibly lower computing costs. Use of an affinity group is preferred, but is optional for other embodiments.

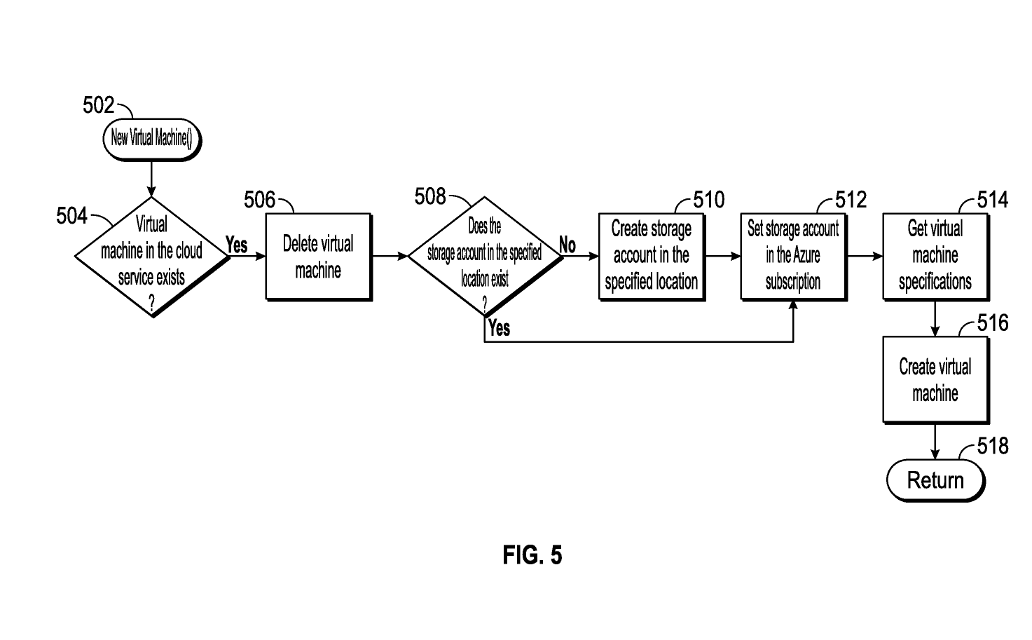

After determining the need for an affinity group (401), the system begins creation of the virtual network (402). The cloud service name is a unique identifier that is assigned prior to creation of a cloud service. If the cloud service name does not already exist (402) then the service name is established prior to creating the first virtual machine (502). If the cloud service name exists (402), then a new virtual machine is added (502) to the existing virtual network. The steps for creation of a virtual machine are provided in detail in the discussion of FIG. 5. Once the virtual machine is created, Windows roles and features are installed, including an Active Directory domain services forest controller that is promoted as the first domain controller for the virtual network (403). Once the domain controller IP address is determined, the first domain name server (DNS) is configured (404) inside the virtual network. If a backup domain controller is desired (405), another virtual machine is created (502), the Windows roles and features are installed including another active directory domain services forest controller that is promoted as a second (backup) domain controller (406). The IP address of the second domain controller is determined and it is set along with the Azure's default DNS server inside the virtual network as well (407). In case that there is no need for a backup domain controller, then only the Azure's default DNS server will be added to the virtual network DNS servers list (408).

Next, with reference to FIG. 4B, domain controller data is obtained from the platform configuration data to determine if any domain controllers should be created (409). A domain controller is a server in a Windows network that manages security authentication requests, allowing users to log in to various resources with a registered username and password. If required (409), the domain controller role is installed on the first domain controller (and second, if previously created) virtual machine. Once all DNS/domain controller virtual machines are configured (411), the system obtains and cycles through the list of additional virtual machines as provided in the platform configuration data. If additional virtual machines exist on the list (412) that are not designated as domain controllers (413), then a new virtual machine is created (502) and the IP address of the virtual machine is stored in the platform database.

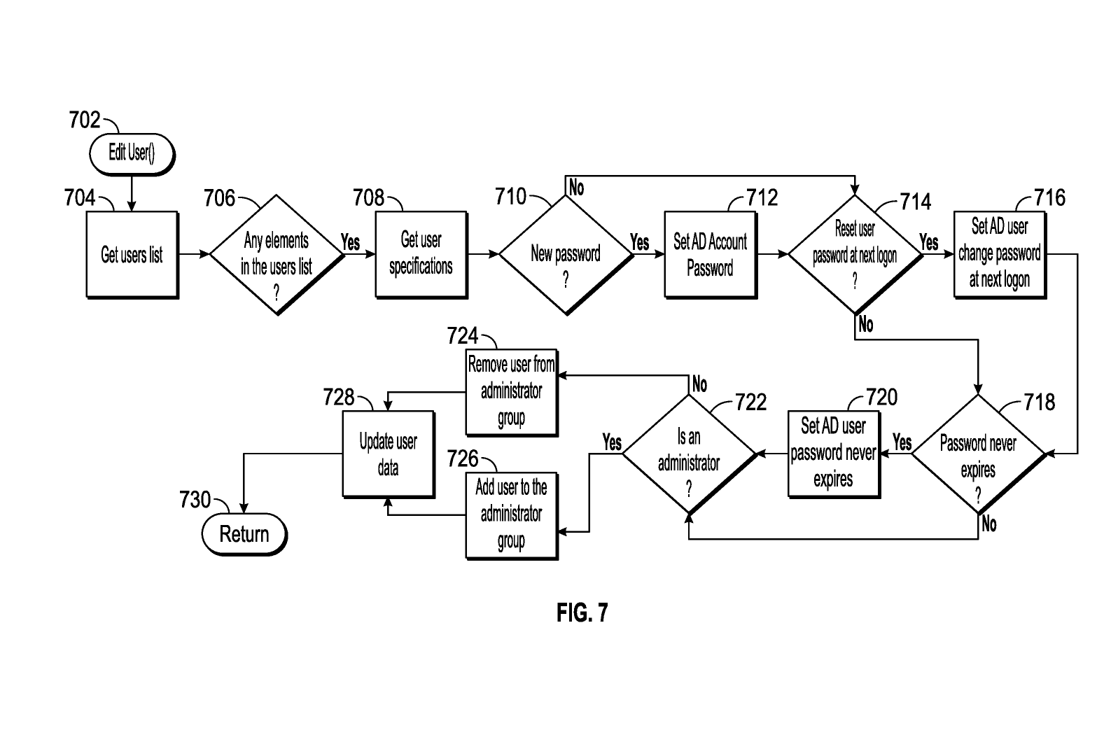

Because of page constraints, FIGS. 4B and 4C present the following. Once all virtual machines have been created (414), the system determines if federation servers are necessary to support an existing Microsoft Office 365 account. The platform creation module checks the federation server and domain controller lists (415) to determine if there is an unequal designation of each and whether the configuration user has indicated a desire to synchronize the system with an existing Office 365 account (416). If elements remain in the configuration data federation server list, additional federation servers are created and the appropriate Windows roles and features are installed (418) thereon. Once the desired number of federation servers is achieved (419) a determination is made as to whether the configuration user Office 365 credentials are set and the federation server role has not been installed in the domain controller virtual machines (420). If this is the case, then the federation servers are halted until such time as they are needed. Next, the platform creation module utilizes the configuration data to set user accounts and roles in an Active Directory group for assignment to the remote desktop session collection groups. The administrator user is first established by editing the user role (702). The steps for editing a user are provided in detail in the discussion of FIG. 7. Once the administrators, users, and groups are created in the first domain controller (421), the administrators and users are added to the appropriate groups and the user principal name (UPN) set in the configuration data is added to the Active Directory Domain Forest in the first domain controller (422).

Next, the system configures the session hosts for user access to remote desktops. The platform creation module then identifies the connection broker, web access server, and session host virtual machines (423) and determines if any session hosts are indicated (424). The list of session hosts is iterated and a Windows feature desktop experience is installed on each session host virtual machine (425). Referring now to FIG. 4D, the platform creation module obtains the list of virtual machines whose roles include the remote desktop gateway server (426), and performs the remote desktop gateway server module configuration on all of them (427). Once the gateway server list is exhausted (428), a gateway farm is established (429) to assist in load balancing.

Next, the platform creation module addresses the list of desired remote desktop web access servers (430). If multiple web access servers are designated (primarily for load balancing reasons) the system increments through the web access servers (431) and configures each to allow access to the session host machines.

Once all web access servers are configured, the platform creation module obtains the needed information from the first domain controller (432) and copies the SSL certificate inside the virtual machine. Then the SSL certificate is configured on each role of the remote desktop services module (RD Connection Broker Single Sign On/Publishing options, RD Gateway and RD Web Access) (433), and also for each host on the session host list (434). After iterating through the session host machines and setting the necessary remote desktop certificates (435), the platform creation module moves onto the domain controller, connection broker, and session host machines to complete the remote desktop configuration (436).

Next, referring to FIG. 4E, a remote desktop session collection is formed (437). The platform creation module determines the session collection members, creates an active directory organizational unit to refer to the members, establishes a group policy object for the organizational unit, and sets the remote desktop session collection group policy settings as appropriate (438). The platform creation module then determines from the remote desktop applications list if any remote desktop applications are desired (440). If remote desktop applications are desired, then the applications are added to the collection group (441) until all apps are added (442). Next, the session hosts (443) are evaluated for resource requirements and the session collection group is optimized for load balancing (444), and a session collection farm name is established in the first DNS server (445) before turning attention to the remote desktop gateway.

After obtaining the configuration data gateway servers list, the platform creation system iterates the list to create the Remote Desktop Gateway Computer Group on each server (447) in order to define the list of the remote desktop virtual computers on the virtual network to which remote users may connect. Referring now to FIG. 4F, the gateway server list (449) is iterated once more (450) to establish a gateway resource authorization policy, which specifies the internal network resources to which the specified active directory users/groups may connect through the gateway. Once the gateway servers have been configured (451) the system moves onto the configuration of the license server (452).

To facilitate proper usage of licensed applications on the remote desktops, it is necessary to instantiate a license server for use by the system (453). Once this is accomplished, a local policy is applied on each session host in order to establish control access to specific user applications (454).

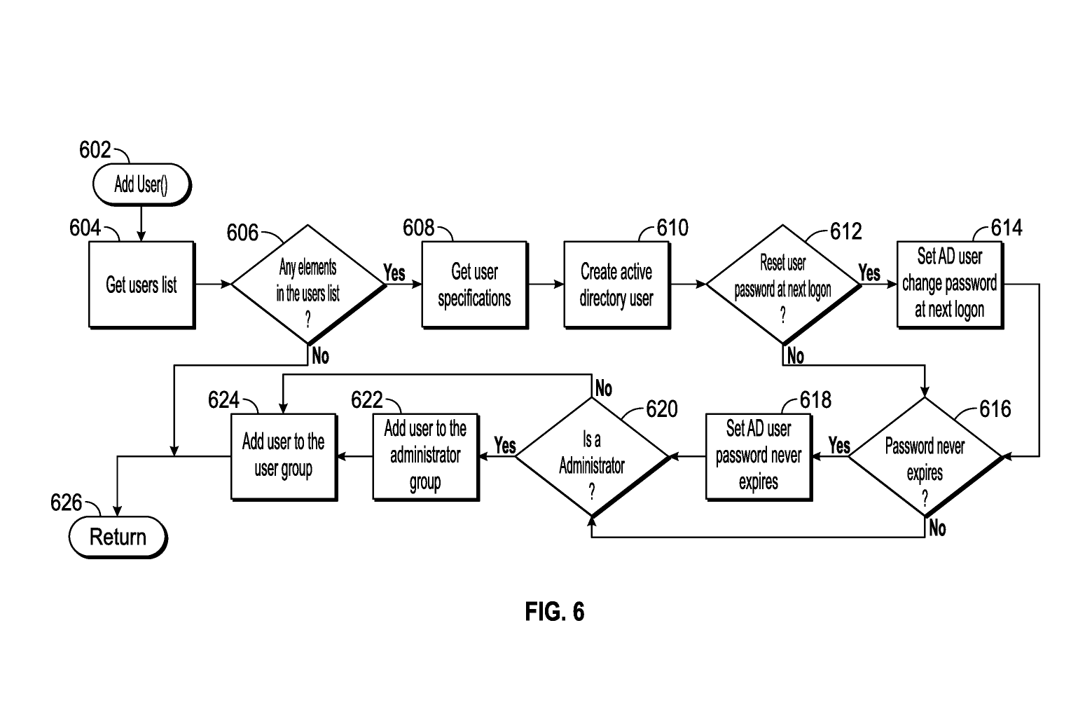

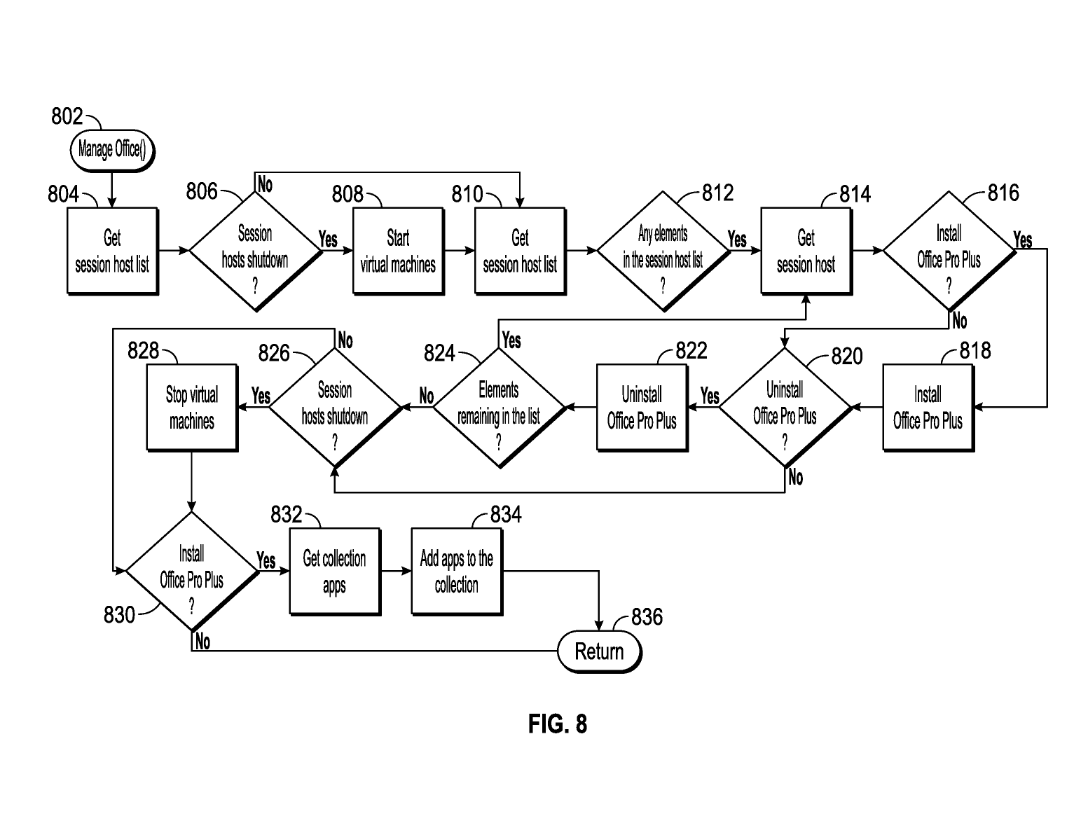

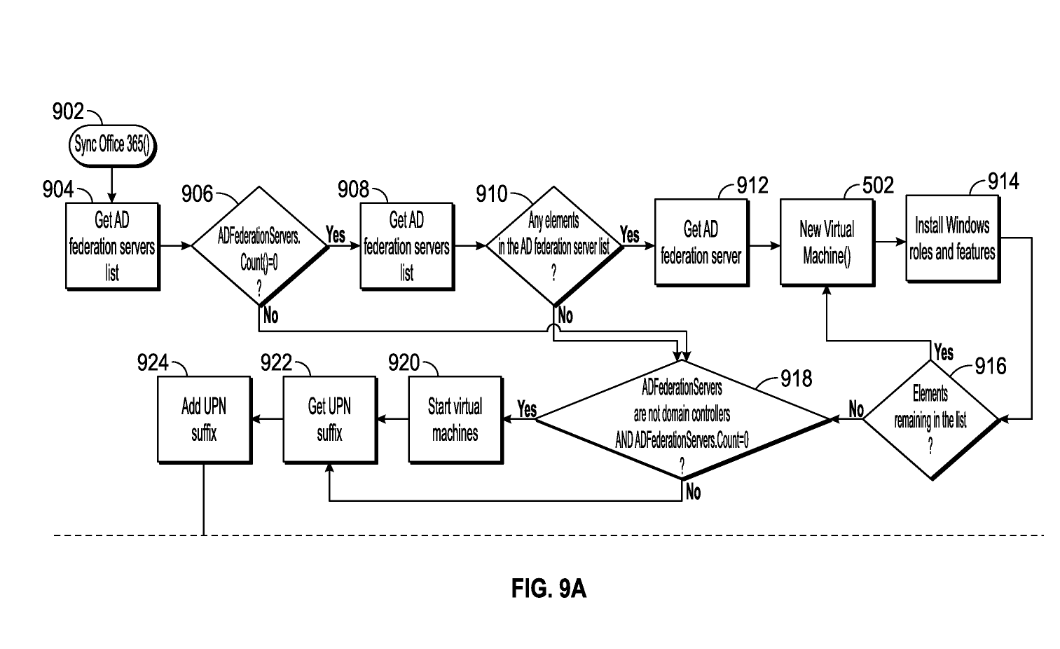

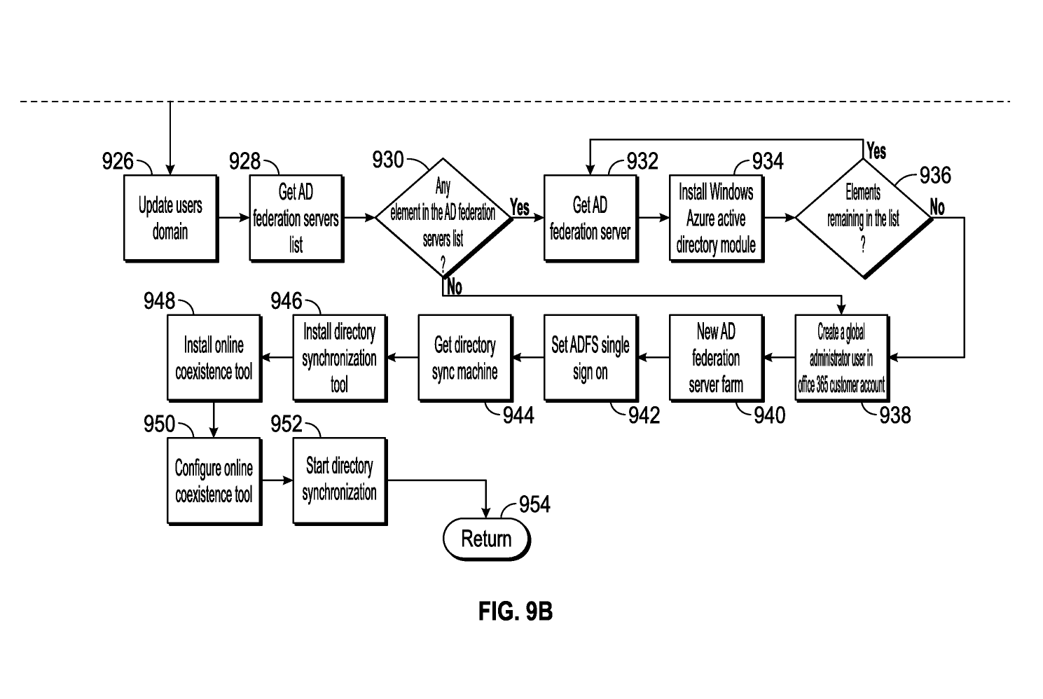

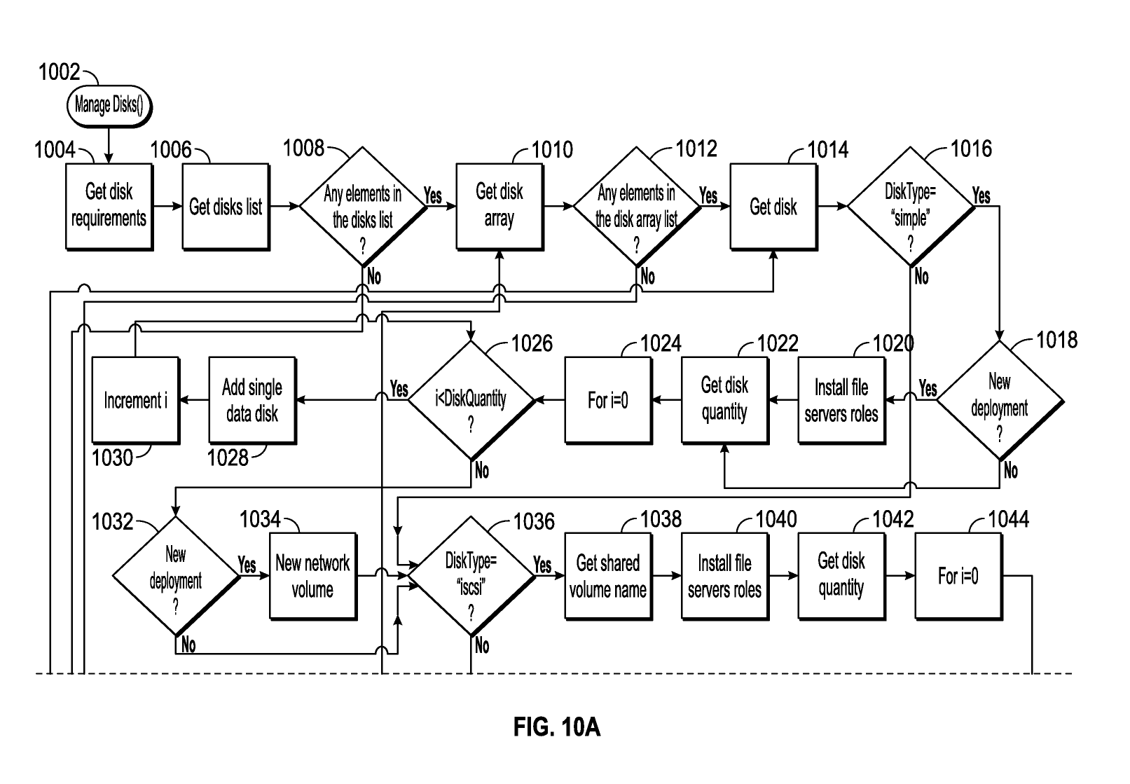

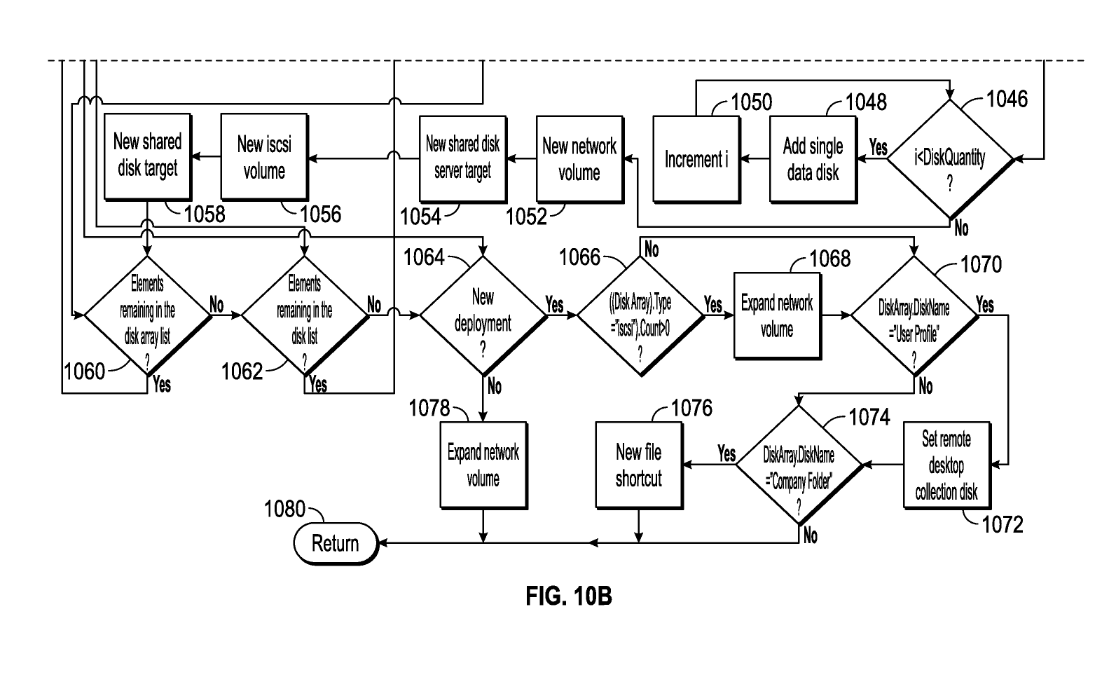

Next, the platform configuration module determines if generic user accounts are necessary by assessing the configuration data. If generic users are desired (455), the generic user requirements are obtained (456) and the generic users are added to the mix of remote desktop users (602). The steps for addition of a new user are provided in detail in the discussion of FIG. 6. A remote desktop user license is established for each generic user (457), until the desired number of generic user accounts is reached (458). Finally, the office productivity software application is installed if desired (459) on each remote desktop instance. The steps for installation of the office application (802) are provided in detail in the discussion of FIG. 8. The steps for managing shared disk space in the virtual network are provided in detail in the discussion of FIG. 10. Finally, the platform configuration module determines if synchronization with Office 365 is desired (460) and, if it is, synchronizes the desktops with the application (902). The steps for Office 365 synchronization are provided in detail in the discussion of FIG. 9. In embodiments in which the remote desktop environment is other than Microsoft Windows, other appropriate office productivity software may be made available that is suitable to the virtual operating system being hosted.

FIG. 5 is a flow diagram of an embodiment of a subset of the program steps taken by the platform creation module with regard to creation and configuration of virtual machines. When a new virtual machine is desired (502), the platform configuration module first ascertains whether or not the requested virtual machine already exists (504). If it does, then the machine is deleted in order to prevent the overuse and misallocation of system resources (506). System data storage must then be allocated for the virtual machine. To achieve this, the Microsoft Azure IT infrastructure platform requires a storage account. The platform creation module checks to see if a valid storage location exists (508) and creates one if it does not (510). The storage account is then recorded in the IT infrastructure platform subscription (512) and the virtual machine configuration specifications are obtained (514) and the virtual machine is created (516) and is ready to use (518).

FIG. 6 is a flow diagram of an embodiment of a subset of the program steps taken by the platform creation module with regard to adding a user to the system. When the platform creation module seeks to add an Active Directory user (602), the user list is extracted from the configuration data (604). After parsing the list (606), the corresponding user specifications are obtained (608) and an Active directory user instance is instantiated (610). User password policies are then established, including whether the password should be reset at next logon (612) and whether the password expires (616) or if it should be set to never expire (618). If the particular new user is an administrator (620), the user is added to the administrators group (622) as well as the user group (624). If the new user is not an administrator, then the user is added only to the user group (624) before returning (626).

FIG. 7 is a flow diagram of an embodiment of a subset of the program steps taken by the platform creation module with regard to modifying established Active Directory user accounts. When a request to edit a user is received (702), the user list data is obtained (704) and parsed for elements (706). After obtaining the user details (708), if a password change is desired (710) a new account password is set (712). If it is desired that the user reset the password at the next logon (714), then the system is set to request a password change at the next logon by the user (716). If it is desired that the password is to never expire, then the system sets the password to never expire (720). If the user being edited is designated an administrator (722), the user is added to the administrators group (726) and the user data is updated (728). If the user is being demoted from an administrator role (722), then user is removed from the administrators group (724) and the user data is updated (728) before returning to the main processing flow (730).

FIG. 8 is a flow diagram of an embodiment of a subset of the program steps taken by the platform creation module with regard to configuration of the remotely accessible desktops to support a productivity software application. When it is desired to manage the remote desktop software application (802), the platform creation module obtains the session host listing and ensures that each session host is operational (806) and, if not, starts the virtual machine (808). On iterating through the session host list (810), the module determines if it is desired to install the software application (816) and, if yes, the software application is installed (818). If it is desired to uninstall the application (820), the application is uninstalled (822). If all session hosts have been processed (824), and if any of them were initially offline then the system will shut them down (826), then the virtual machines are stopped (828). If the application was just installed (830), then the existing collection apps are obtained (832) and the newly added application is added to the collection (834) before returning (836). As depicted, the application is the Microsoft Office utility. Other embodiments may utilize productivity software applications appropriate for the host operating system.

FIG. 9 is a flow diagram of an embodiment of a subset of the program steps taken by the platform creation module with regard to synchronizing supported productivity software application data with the respective user desktops. Referring to FIG. 9A, when a configuration user has indicated during system configuration that Office 365 synchronization is desired, the platform creation module configuration scripts call this subroutine (902). The module first obtains a list of the existing Active directory federation servers (904), and if no federation servers currently exist (906), parses the list (908) to extract configuration elements (910) and instantiates a new virtual machine (502) to support a new instance of a federation server (912). Windows roles and features are added to the federation server (914) and the process repeats (916) until all desired federation servers are created and configured.

Next, if the federation server is not already running (918) it is started (920). The system then obtains the UPN suffix of the requesting user account (922) and sets the identity on the federation server (924) and, referring now to FIG. 9B, updates the user domain (926). The federation server list is again iterated (928) to obtain the list elements (930), and the Windows Azure active directory module is installed (934) on each federation server (932). Once completed (936), a global administrator user is created for the Office 365 customer account. The system then creates an active directory federation server farm to organize the servers (940) and establishes a single sign on (942). The location of the Office 365 directory synchronization machine is obtained (944) and the directory synchronization tool is installed (946). Next, the online coexistence tool is installed (948) and configured (950) and synchronization is begun (952) as processing is returned to the platform creation module main script (954).

FIG. 10 is a flow diagram of an embodiment of a subset of the program steps taken by the platform creation module with regard to management of storage space for the created user desktops and company shared folder. When the platform creation module wishes to create and manage disks (1002), it first obtains the disk requirements from the configuration parameters (1004) and parses through the disks list (1006), element by element (1008) to determine the disk array (1010) and disk (1014) information. The system iterates the disk array (1012) in order to add the required data disks to the proper virtual machines. If the disks to add are of a single type (1016), then all of them are added (1022) to the corresponding virtual machine (1028). If the disks to add are of the type iSCSI (1036), then the disks are added executing the following steps: Obtain a unique name to be assigned to the network disk (1038), add as many data disks to the virtual machine as the array indicates (1048), create a new network volume in the virtual machine using the recently added data disks as a storage pool (1052), create a new shared iSCSI disk server target (1054), create a new iSCSI drive using the newly created network volume (1056), and the first session host of the platform as the iSCSI drive target (1058). Once all the disks defined in the arrays have been added and configured if needed, if it is a new deployment in the platform, a new network volume is created in the first session host using all the single and iSCSI drives that were added to the virtual machines set (1066, 1068). If the purpose of the disk array is to create the Users Profile Disk pool (1070), the remote desktop collection disk feature is configured in the remote desktop connection broker (1072), if its purpose is to create the platform's company shared folder, then the system creates the file shortcut in the desktop and assigns read/write permissions to it (1076). In the case that it is not a new deployment, the already existing volume in the session host is expanded to the new volume capacity regardless of its purpose (1078).

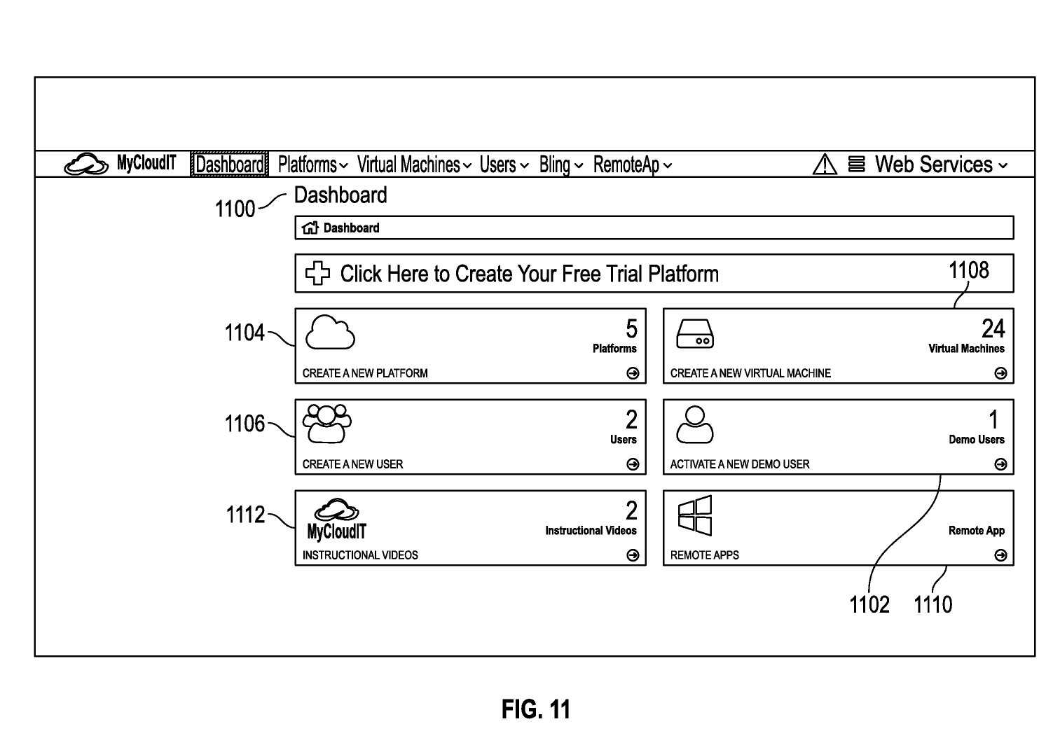

FIG. 11 is a depiction of an embodiment of a first screen of the user interface as provided by the IT infrastructure portal, in particular, the interface that a configuration user sees when logging into the system (1100). As depicted, the user is presented with selectable “button” interface elements that are generated and enabled by the underlying HTML and JavaScript software code. The configuration user has the option to activate a virtual network demo user (1102) to test the system on a trial basis, create a new virtual network platform (1104), create (or manage) a user (1106), create a new virtual machine for a user (1108), manage the accessibility of remote applications that are available to the user through the user's remote desktop (1110), and view videos that provide instruction for use of the system (1112). Additional information is provided on each element to provide a quick indication of various environmental details. For example, the platform creation element (1104) provides a count of the number of platforms currently being managed by the platform creation module, while the create a new user element (1106) provides a count of the number of users that are currently being managed. Likewise, the virtual machine element (1108) provides a quick indication of the number of virtual machines currently being managed by the platform creation module. The configuration and/or management user logs into and out of the system from this initial dashboard (100).

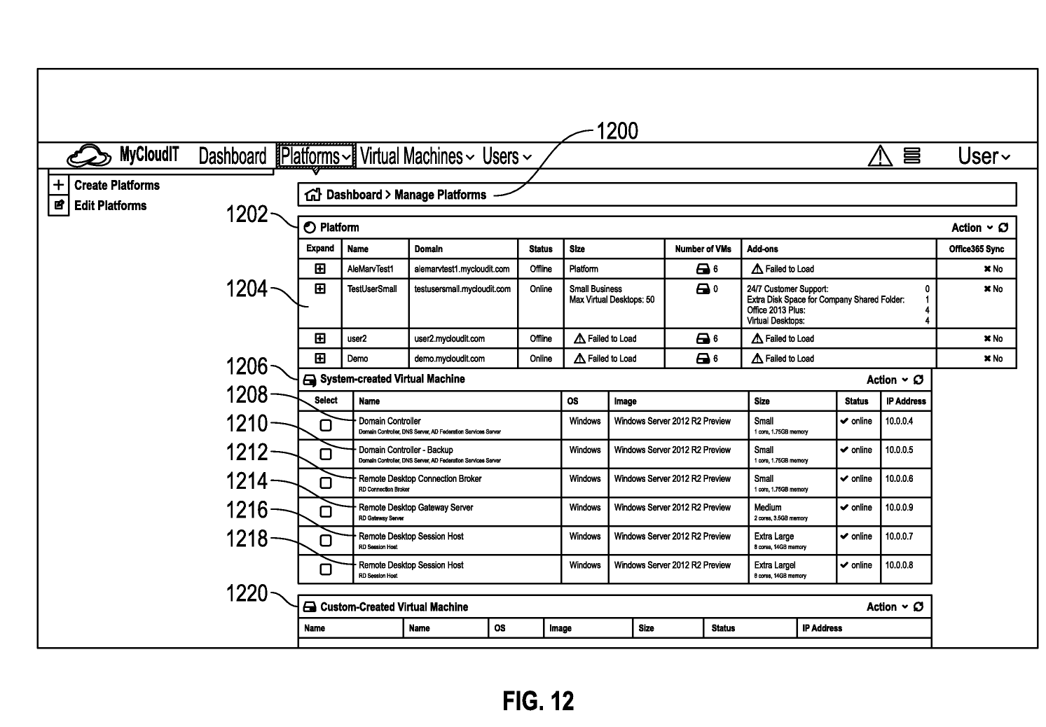

FIG. 12 is a depiction of an embodiment of a second screen of the user interface as provided by the IT infrastructure portal, in particular, the interface for managing the IT infrastructure platform device virtual computer network (1200). As depicted, the user is presented with indications concerning the base virtual network platform (1202), the system-created virtual machines (1206), and custom-created virtual machines (1220). Specific virtual network platform information (1204) includes network name identifier; the domain to which the network belongs; the operational status; the network size; the number of virtual machines associated with the network; add-ons (for example, the number of extra disks, software applications, virtual desktops associated with the network, etc.); and whether the network is configured to synchronize with the Office 365 productivity application. Other embodiments that provide, for example, a UNIX variant or other computer network arrangement will likely provide a productivity software application package that is appropriate for the operating system.

The system-created virtual machine element (1206) includes a listing of the virtual machines that the platform creation module instantiates to construct the virtual network. Depicted is the existence of the domain controllers, both primary (1208) and backup (1210); the remote desktop connection broker (1212); the remote desktop gateway server (1214); and the two remote desktop session hosts (1216 and 1218). The information provided for each includes the name of the virtual machine; the operating system type; the disk image that is currently installed; the size of the associated storage disks; the operational status, and the virtual network IP address for the particular virtual machine. In the present embodiment the Microsoft Windows OS is present on each of the virtual machines. However, in other embodiments it is possible to mix OS types, for example, providing a Windows remote desktop session host for Windows users along with a UNIX variant remote desktop session host for UNIX users.

The custom-created virtual machine element (1220) presents the same information as the system-created virtual machine element (1206), but reports to the configuration/management user all user-created virtual machines. For example, custom created virtual machines may include additional database servers, web servers, user remote desktop machines, Unix-based machines, and the like.

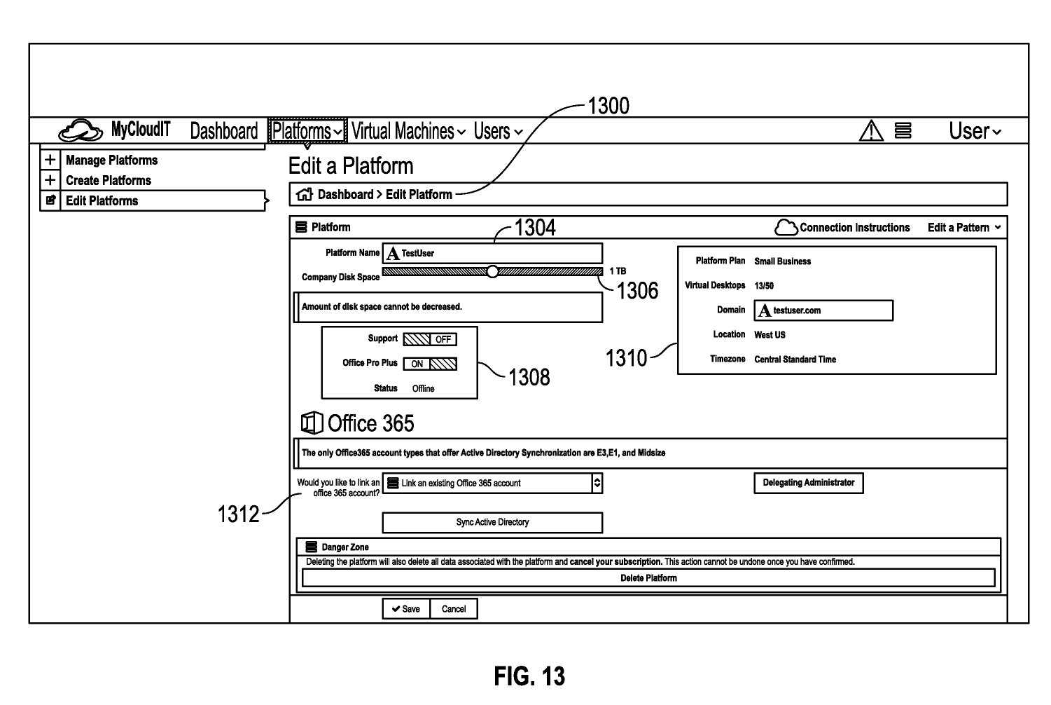

FIG. 13 is a depiction of an embodiment of a third screen of the user interface as provided by the IT infrastructure portal, in particular, the interface for editing a created IT infrastructure platform device virtual computer network (1300). When desiring to configure or manage an existing platform (1300), the user is presented with platform specific information including the platform name (1304); the current operational plan (1310); the amount of shared disk space (1306); application support status (1308); and productivity software details (1312). From this interface it is possible to edit the information and reconfigure the platform. For example, the user may increase system disk space by moving the slider widget (1306) to the desired capacity. Likewise, if the configuration/management user wishes to change the support level or the productivity software available on the remote desktop virtual machines, the appropriate information may be provided (1308). In the present embodiment details concerning the Office 365 productivity application may be modified as well (1312). For example, the user may link the platform to an existing (external) Office 365 account. The platform may also be deleted in its entirety from this interface page, which would destroy all associated data and end the user subscription to the service.

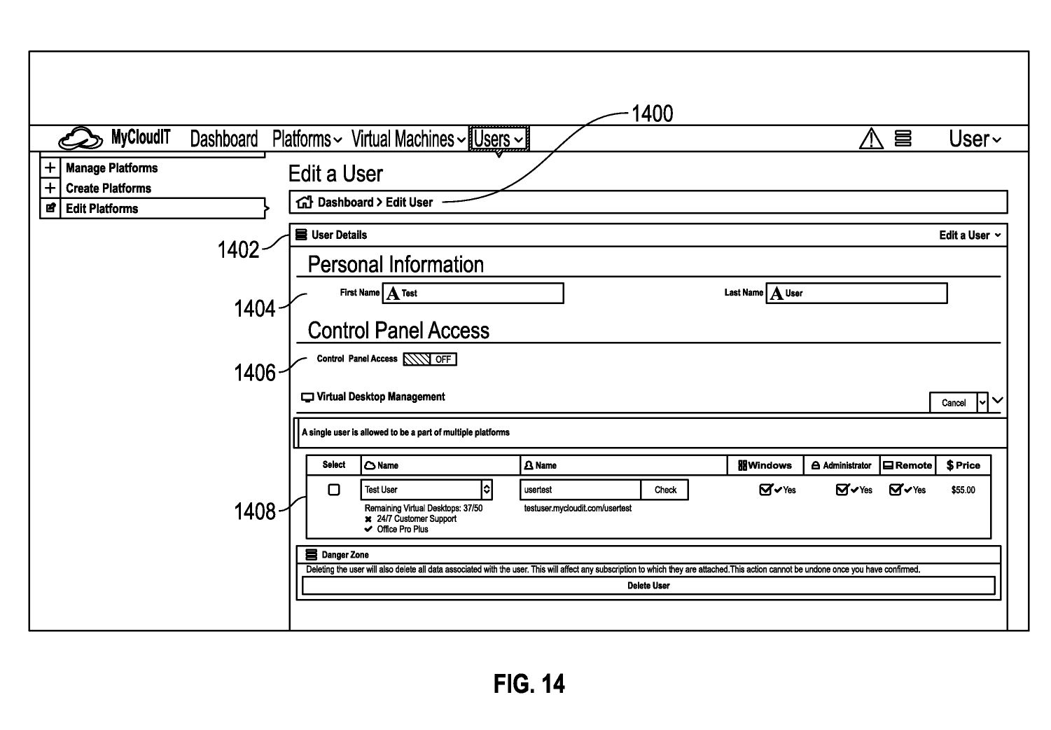

FIG. 14 is a depiction of an embodiment of a fourth screen of the user interface as provided by the IT infrastructure portal, in particular, the interface for editing a created user account (1400). This interface page allows the configuration/management user to perform the steps required to create, manage, or remove a remote desktop user from the virtual computer network. User details are presented (1402), including user name (1404), access privileges (1406), and roles/groups (1408). The configuration/management user may modify the user information and may select the particular roles that the user may take (for example, administrator and/or standard Windows user).

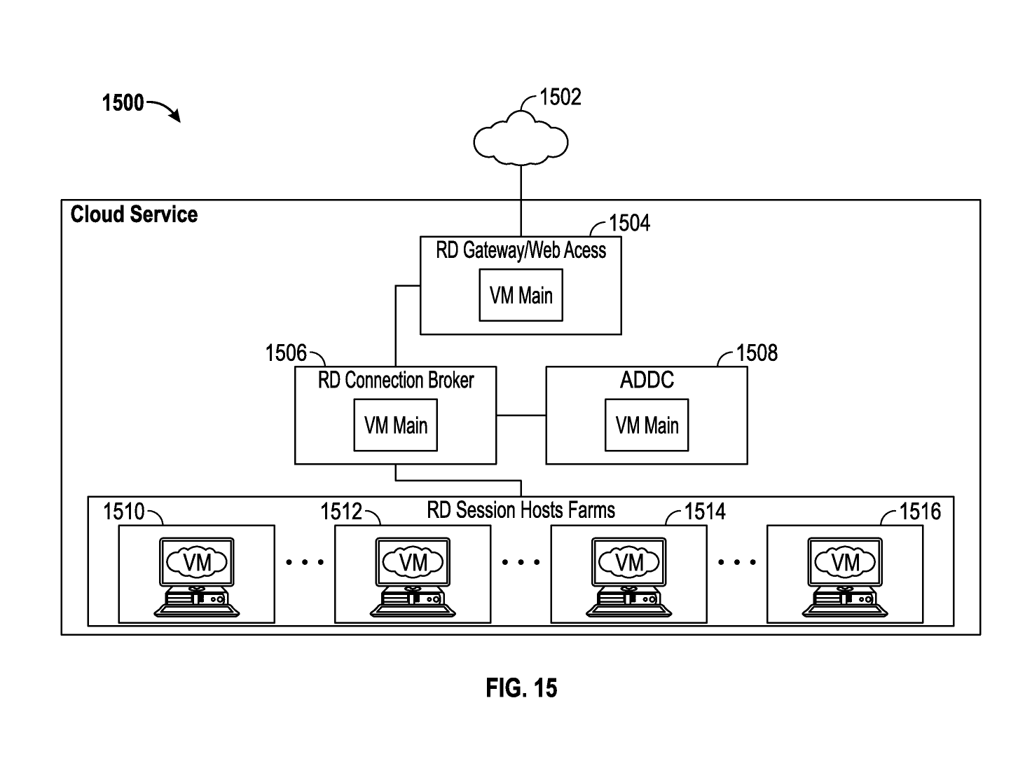

FIG. 15 is a block diagram of the elements of another embodiment of the IT infrastructure platform device of the present invention. This diagram represents an alternate configuration for the virtual network (1500). Depicted is the standard arrangement of remote desktop gateway/web access server (1504), remote desktop connection broker (1506), and active directory domain controller/DNS (1508). However, the virtual machines are clustered in individual remote desktop session host farms (1510, 1512, 1514, and 1516), such that each farm is independent and represents the assets of specific corporate remote desktop user departments. This allows for isolated resources per department, and is scalable for growth of the corporation. Access to the remote desktops is over the computer network (1502) through the single gateway (1504).

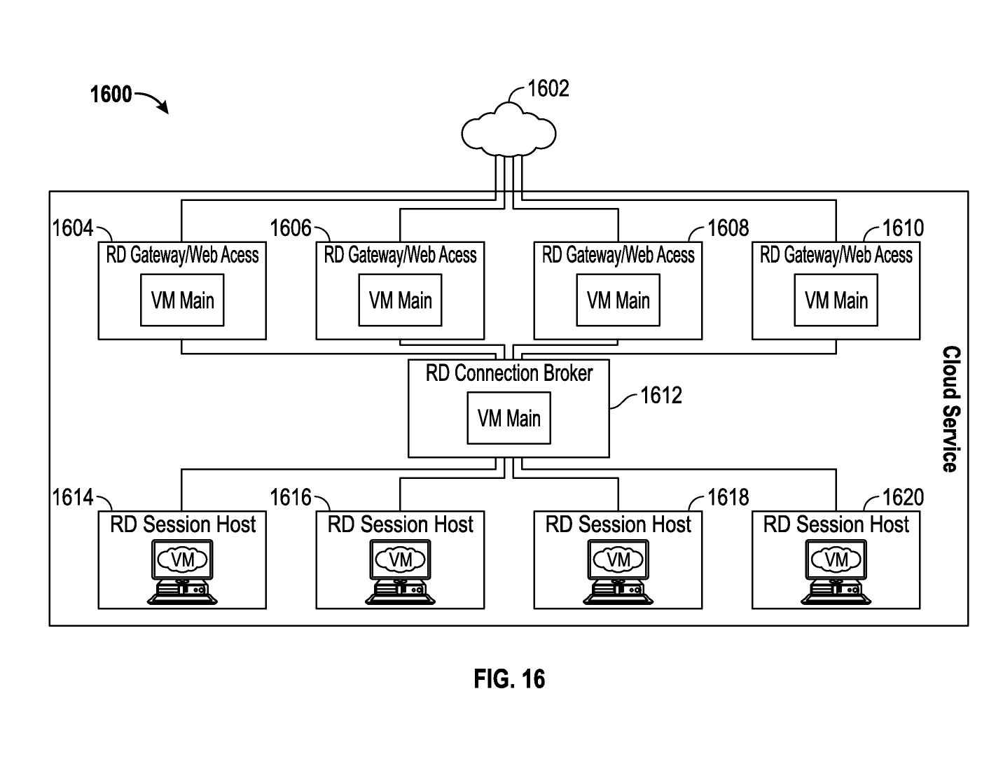

FIG. 16 is a block diagram of the elements of yet another embodiment of the IT infrastructure platform device of the present invention. This configuration utilizes multiple remote desktop gateway/web access servers (1604, 1606, 1608, and 1610) that act independently, through a remote desktop connection broker (1612), to connect with a dedicated remote desktop session host farms (1614, 1616, 1618, and 1620, respectively). Having a dedicated gateway server for each session host farm affords maximum flexibility for an IT reseller to customize the virtual network platform to an end user's needs.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes that come within the meaning and range of equivalency of the claims are embraced therein. Further, the recitation of method steps does not denote a particular sequence for execution of the steps. Such method steps may therefore be performed in a sequence other than that recited unless the particular claim expressly states otherwise.

I claim:

1. A system for virtualizing an information technology (IT) infrastructure, the system comprising:
a computer network accessible IT infrastructure platform device, the IT infrastructure platform device comprising computing resources adapted to support the operation and TCP/IP connectivity of a plurality of virtual machines thereon; and
a computer network accessible IT infrastructure portal device in network communication with the IT infrastructure platform device, the IT infrastructure portal comprising a platform management interface for requesting and receiving platform configuration data from a configuration user and for presenting IT infrastructure platform data to the configuration user, the portal further comprising a platform creation module adapted to create on the IT infrastructure platform device a virtual computer network accessible over the TCP/IP computer network and comprising at least one remotely accessible virtual desktop.

2. The system of claim 1, wherein the platform creation module configures and manages the IT infrastructure platform device based upon the received platform configuration data, wherein the received platform configuration data includes a count of the desired number of virtual desktops and a desired storage capacity size value representing the desired shared hard drive storage space to allocate within the IT infrastructure platform.

3. The system of claim 1, the IT infrastructure portal further comprising:
a desktop user management interface for managing remote desktop user accounts.

4. The system of claim 1, the IT infrastructure portal further comprising:
a virtual machine management interface for managing the virtual machines.

5. The system of claim 1, the system further comprising:
one or more virtual machines operable as a remote desktop gateway server, one or more virtual machines operable as a remote desktop connection broker server, one or more virtual machines operable as a remote desktop web access server, one or more virtual machines operable as a remote desktop session host server, and one or more virtual machines operable as a domain name server, wherein each virtual machine is in network connectivity to provide a desktop user with a remotely accessible virtual desktop.

6. The system of claim 5, the system further comprising one or more virtual machines operable as an active directory domain controller and one or more virtual machines operable as an active directory federation server.

7. The system of claim 5, wherein the platform configuration data comprises a desired storage capacity size value representing shared hard drive storage space within the created IT infrastructure, the system further comprising:
a hard drive storage space created by the platform creation module, the storage space capacity determined by a received storage capacity size value, wherein the hard drive storage space is shared among the remote desktops.

8. The system of claim 5, wherein the platform configuration data comprises a count of the desired number of virtual desktops for the created IT infrastructure, and wherein the number of virtual machines operable as a remote desktop session host server is determined by a received count of the desired number of virtual desktops.

9. The system of claim 5, wherein the platform configuration data comprises a listing of one or more software applications accessible by a remote desktop user, the system further comprising:
software applications consistent with a received listing of software applications and provided by the desktop session host servers.

10. A method for virtualizing an information technology (IT) infrastructure, the method steps comprising:
providing a computer network accessible IT infrastructure platform device, the IT infrastructure platform device comprising computing resources adapted to support the operation and TCP/IP connectivity of a plurality of virtual machines thereon;
providing a computer network accessible IT infrastructure portal in network communication with the IT infrastructure platform device, the IT infrastructure portal comprising a platform management interface for requesting and receiving platform configuration data from a configuration user and for presenting IT infrastructure platform data to the configuration user, the portal further comprising a platform creation module adapted to create on the IT infrastructure platform device a virtual computer network accessible over the TCP/IP computer network and comprising at least one remotely accessible virtual desktop.

11. The method of claim 10, the method steps further comprising, with the platform creation module:
creating, on the IT infrastructure platform device, one or more virtual machines operating as a remote desktop session host server to provide remote desktop access to one or more remote desktop users.

12. The method of claim 10, the method steps further comprising, with the platform creation module:
creating, on the IT infrastructure platform device, one or more virtual machines operating as a remote desktop session host server, one or more virtual machines operating as a remote desktop connection broker server, one or more virtual machines operating as a remote desktop web access server, and one or more virtual machines operating as a remote desktop gateway server to provide remote desktop access to one or more remote desktop users.

13. The method of claim 12, the method steps further comprising, with the platform creation module:
creating, on the IT infrastructure platform device, one ore more virtual machines operating as an active directory domain controller server; and
creating, on the IT infrastructure platform device, one ore more virtual machines operating as an active directory federation server.

14. The method of claim 12, wherein the platform configuration data comprises a desired storage capacity size value representing shared hard drive storage space within the created IT infrastructure, the method steps further comprising:
creating, on the IT infrastructure platform device, a hard drive storage space consistent with a received storage capacity size value wherein the hard drive storage space is shared among the remote desktops.

15. The method of claim 12, wherein the platform configuration data comprises a count of the desired number of virtual desktops for the created IT infrastructure, the method steps further comprising:
creating, on the IT infrastructure platform device, a number of remote desktop session host servers consistent with a received count of the desired number of virtual desktops.

16. The method of claim 12, wherein the platform configuration data comprises a listing of software applications accessible by a remote desktop user, the method steps further comprising:
installing, on the created desktop session host servers, software applications consistent with a received listing of software applications, the installed software applications accessible from a remote desktop session.

17. A method for virtualizing an information technology (IT) infrastructure, the method steps comprising:
providing a computer network accessible IT infrastructure portal in network communication with a computer network accessible IT infrastructure platform device, the IT infrastructure portal comprising a user interface for requesting and receiving platform configuration data from a configuration user and for presenting IT infrastructure platform operational data to the configuration user, the IT infrastructure portal further comprising a platform creation module;
receiving, with the IT infrastructure portal, platform configuration data from a configuration user, the platform configuration data including a count of a desired number of virtual desktops; and
creating, on a computer network accessible IT infrastructure platform device and in response to the received platform configuration data, one or more virtual machines operating as a remote desktop session host server, one or more virtual machines operating as a remote desktop connection broker server, one or more virtual machines operating as a remote desktop web access server and one or more virtual machines operating as a remote desktop gateway server to provide remote desktop access to a desktop user.

18. The method of claim 17, the method steps further comprising:
creating, on the IT infrastructure platform device, one ore more virtual machines operating as an active directory domain controller server; and
creating, on the IT infrastructure platform device, one ore more virtual machines operating as an active directory federation server.

19. The method of claim 17, wherein the platform configuration data comprises a desired storage capacity size value representing shared hard drive storage space within the created IT infrastructure, the method steps further comprising:
creating, on the IT infrastructure platform device, a hard drive storage space consistent with a received storage capacity size value wherein the hard drive storage space is shared among the remote desktops.

20. The method of claim 17, wherein the platform configuration data comprises a count of the desired number of virtual desktops for the created IT infrastructure, the method steps further comprising:
creating, on the IT infrastructure platform device, a number of remote desktop session host servers consistent with a received count of the desired number of virtual desktops.

21. The method of claim 17, wherein the platform configuration data comprises a listing of software applications accessible by a remote desktop user, the method steps further comprising:
installing, on the created desktop session host servers, software applications consistent with a received listing of software applications, the installed software applications accessible from a remote desktop session.
